(19) United States
(12) Patent Application Publication
(10) Pub. No.: US 2024/0010097 A1
(43) Pub. Date: Jan. 11, 2024

(54) CHARGING CONTROL APPARATUS, CHARGING CONTROL SYSTEM, CHARGING SERVICE PROVIDING METHOD, AND INFORMATION PRESENTING METHOD

(71) Applicant: Panasonic Intellectual Property Management Co., Ltd., Osaka (JP)

(72) Inventors: Takuya NAKAGAWA, Shiga (JP); Fumio KOSUGE, Kanagawa (JP); Masao IKEDA, Kanagawa (JP)

(73) Assignee: Panasonic Intellectual Property Management Co., Ltd., Osaka (JP)

(21) Appl. No.: 18/370,979

(22) Filed: Sep. 21, 2023

Related U.S. Application Data
(63) Continuation of application No. PCT/JP2021/047487, filed on Dec. 22, 2021.

(30) Foreign Application Priority Data
Mar. 22, 2021 (JP) 2021-047427

(51) Int. Cl. B60L 53/66; B60L 53/12; B60L 58/12

(52) U.S. Cl. CPC B60L 53/66; B60L 53/12; B60L 58/12

(57) ABSTRACT

A charging control apparatus, a charging control system, a charging service providing method, and an information presenting method are disclosed. The charging control apparatus includes: a time receiver that receives information indicating a scheduled parking time of a vehicle in a parking space where a power transmitter corresponding to a power receiver mounted on the vehicle is installed; a state of charge receiver that receives information indicating a target state of charge of a storage battery for traveling mounted on the vehicle; and a current controller that controls a charging current of the storage battery for traveling in such a way that a state of charge of the storage battery for traveling reaches the target state of charge when the scheduled parking time has passed.

### BACKGROUND

### Technical Field

The present disclosure relates to a charging control apparatus, charging control system, a method for providing a charging service (herein also referred to as “charging service providing method”) and a method for presenting information (herein also referred to as “information presenting method”).

### Description of the Related Art

Patent Literature (hereinafter, referred to as PTL) 1 (Japanese Patent Application Laid-Open No. 2020-102220) discloses an automated valet parking system configured to move by automatic driving a vehicle that is parked in a parking space capable of recharging batteries to a vacant parking space when the storage battery for traveling mounted in the vehicle is fully charged.

### BRIEF SUMMARY

Non-limiting examples of the present disclosure facilitate providing a charging control apparatus, charging control system, a charging service providing method, and an information presenting method each capable of achieving optimal charging control when the parking time varies from vehicle to vehicle.

A charging control apparatus according to one embodiment of the present disclosure includes: a time receiver that receives information indicating a scheduled parking time of a vehicle in a parking space where a power transmitter corresponding to a power receiver mounted on the vehicle is installed; a state of charge receiver that receives information indicating a target state of charge of a storage battery for traveling mounted on the vehicle; and a current controller that controls a charging current of the storage battery for traveling in such a way that a state of charge of the storage battery for traveling reaches the target state of charge when the scheduled parking time has passed.

A charging control system according to one embodiment of the present disclosure includes: the above-described charging control apparatus and the power transmitter.

A charging service providing method according to one embodiment of the present disclosure includes: receiving, from an information terminal, information indicating a scheduled parking time of a vehicle in a parking space where a power transmitter corresponding to a power receiver mounted on the vehicle is installed and information indicating a target state of charge of a storage battery for traveling mounted on the vehicle; when it is possible to control a charging current of the storage battery for traveling in such a way that a state of charge of the storage battery for traveling reaches the target state of charge when the scheduled parking time has passed, transmitting notification information notifying that parking in the parking space has been received to the information terminal and performing control of the charging current; and when it is not possible to control the charging current of the storage battery for traveling in such a way that the state of charge reaches the target state of charge when the scheduled parking time has passed, transmitting notification information notifying that the state of charge does reach the target state of charge to the information terminal.

An information presenting method according to one embodiment of the present disclosure is a method for presenting information on an information terminal and includes: transmitting information indicating a scheduled parking time of a vehicle in a parking space where a power transmitter corresponding to a power receiver mounted on the vehicle is installed and information indicating a target state of charge of a storage battery for traveling mounted on the vehicle; and when charging the storage battery for traveling up to the target state of charge is possible by performing control of a charging current of the storage battery for traveling in such a way that a state of charge of the storage battery for traveling reaches the target state of charge when the scheduled parking time has passed, outputting a notification indicating that parking in the parking space has been received.

One embodiment of the present disclosure is capable of providing a charging control apparatus, charging control system, a charging service providing method, and an information presenting method each capable of achieving optimal charging control when the parking time varies from vehicle to vehicle.

Additional benefits and advantages of an embodiment of the present disclosure will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a configuration example of automated valet parking system 100 according to one embodiment of the present disclosure;

FIG. 2 illustrates respective configuration examples of user authentication server 1 and an AVP service server 2;

FIG. 3 illustrates respective configuration examples of a server of service during parking (herein also referred to as “during-parking service server”) 3, control server 4, and infrastructure camera 5;

FIG. 4 illustrates a configuration example of mobile terminal device 130;

FIG. 5 illustrates a configuration example of vehicle 140;

FIG. 6 is a sequence diagram for explaining the operation of automated valet parking system 100;

FIG. 7 is a sequence diagram for explaining the operation of automated valet parking system 100;

FIG. 8 illustrates a configuration example of a hardware in automated valet parking apparatus 121;

FIG. 9 illustrates a configuration example of during-parking service server 3A;

FIG. 10 is a flow chart for explaining the operation of charging control apparatus 30;

FIG. 11 illustrates changes in current, temperature, and the like during charging; and

FIG. 12 illustrates changes in current, temperature, and the like during charging.

### DETAILED DESCRIPTION

Hereinafter, at least one preferred embodiment of the present disclosure will be described in detail with reference to the accompanying drawings. In the present specification and drawings, components having substantially the same functions are denoted by the same reference signs and the repetitive descriptions thereof are omitted.

### Embodiments

First, the background leading to the creation of the embodiments according to the present disclosure will be described.

For example, the known technology as described in PTL 1 discloses an automated valet parking system configured to move, by automatic driving, a vehicle parked in a parking space capable of recharging batteries to a vacant parking space when a storage battery for traveling mounted in the vehicle is fully charged.

However, the prior art disclosed in PTL 1 does not describe any specific method for controlling the charging current of a storage battery for traveling, thus still has a problem of how to achieve optimal charging control when the parking time varies from vehicle to vehicle.

For this reason, it is desirable to achieve optimum charging control when the parking time varies from vehicle to vehicle. Embodiments according to the present disclosure will be described below.

### Automated Valet Parking System 100

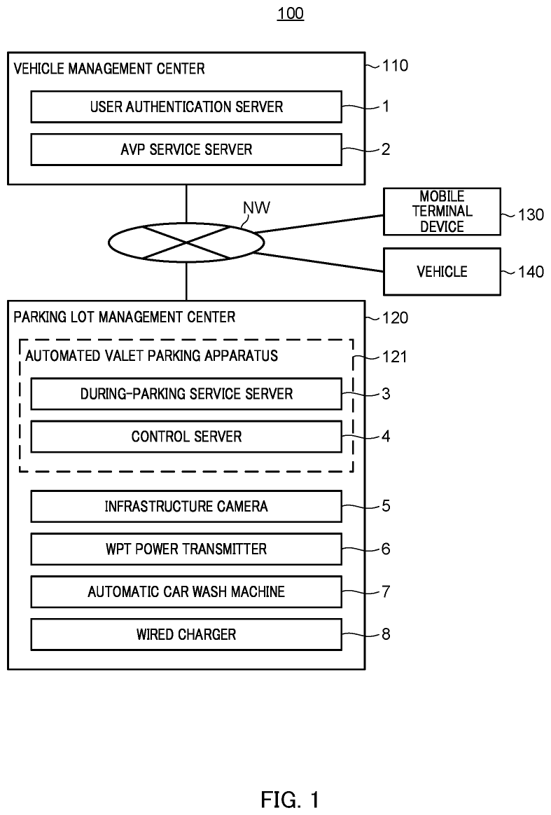

FIG. 1 illustrates a configuration example of automated valet parking system 100 according to one embodiment of the present disclosure. Automated valet parking system 100 includes user authentication server 1, automated valet parking (AVP) service server 2, during-parking service server 3, control server 4, infrastructure camera 5, wireless power transmission (WPT) power transmitter 6, automatic car wash machine 7, wired charger 8, mobile terminal device 130, and vehicle 140. Herein, “automated valet parking” is to move a vehicle to a predetermined parking space by automatic driving control after the passenger gets off at a getting-off position, and then park the vehicle in the parking space.

User authentication server 1 and AVP service server 2 are installed in vehicle management center 110. Vehicle management center 110 manages the identification information of vehicle 140 that uses the automated valet parking service, the identification information of the user of vehicle 140, and the like.

### User Authentication Server 1

User authentication server 1 authenticates the user of vehicle 140.

### AVP Service Server 2

AVP service server 2 manages reservations for automated valet parking services and the like. A reservation for the automated valet parking service is made, for example, by operating an application installed in mobile terminal device 130 owned by the user of vehicle 140.

The reservation method for the automated valet parking service is not limited to the above, and the reservation for the automated valet parking service may be made by operating a navigation device mounted on vehicle 140.

During-parking service server 3, control server 4, infrastructure camera 5, WPT power transmitter 6, automatic car wash machine 7, and wired charger 8 are installed in parking lot management center 120. Parking lot management center 120 manages a parking lot placed in or in a vicinity of a department store, hotel, public facility, or the like.

### During-Parking Service Server 3

During-parking service server 3 manages services that are performed in conjunction with the valet parking service. The services are, for example, a charging service, a car washing service, and a refueling service which are provided to vehicle 140 in the parking space.

Examples of the charging service includes contactless charging by using WPT power transmitter 6 and wired charging by using wired charger 8. The car washing service is a service for automatically washing vehicle 140 by using automatic car wash machine 7.

### WPT Power Transmitter 6

WPT power transmitter 6 is a contactless charger that supplies power to a power receiver mounted on vehicle 140. WPT power transmitter 6 is provided in a parking space. WPT power transmitter 6 includes a power transmitting coil configured to supply power to a power receiver. The power transmitting coil is provided in the parking space so as to face the power receiving coil in a power receiver when the power receiver is moved to a position above the WPT power transmitter 6. The details of the configuration of the power receiver will be described below. The WPT power transmitter/receiver charging system includes (1) a class related to rated power and (2) a class related to vehicle height. These classes differ for each type of vehicle 140; thus it is necessary to guide vehicle 140 to a parking space in which WPT power transmitter 6 of a charging system suitable for the type of vehicle is installed.

### Control Server 4

Control server 4 wirelessly communicates with vehicle 140 arriving at a parking lot where the valet parking service is enabled, and automatically runs vehicle 140 (whose passenger has gotten off at the entrance of the parking lot) to guide the vehicle to the front of a vacant parking space.

In addition, control server 4 transmits an execution signal for automatic parking to vehicle 140 guided to the front of the vacant parking space in order to park vehicle 140 in the vacant parking space.

Infrastructure camera 5 is a camera for capturing an image or a video of vehicle 140 in a parking lot.

### Configuration Example 1 of Infrastructure Camera 5

Infrastructure camera 5 captures an image inside a parking lot and analyzes the captured image data to identify, for example, the vehicle registration number written on the license plate. Infrastructure camera 5 transmits vehicle information including the identified vehicle registration number to user authentication server 1. The vehicle information relates to vehicle specifications. User authentication server 1 authenticates the user of vehicle 140 based on the vehicle registration number.

### Configuration Example 2 of Infrastructure Camera 5

Infrastructure camera 5 captures an image of one or more parking spaces in the parking lot and analyzes the captured image data to determine whether the one or more parking spaces, where WPT power transmitters 6 are installed, are in use.

When all the parking spaces are in use, infrastructure camera 5 determines that the parking lot is full (full state), and transmits full state information indicating the full state to control server 4. In this case, control server 4 cannot guide vehicle 140 to a vacant parking space (i.e., in a vacant state), thus suspends the calculation of the travel route to a vacant parking space.

When at least one parking space is vacant, infrastructure camera 5 determines that the parking space is in a vacant state and transmits vacant parking space identification information to control server 4. The vacant parking space identification information is information indicating the location of the vacant parking space.

### Automatic Car Wash Machine 7

Automatic car wash machine 7 is a car wash machine for automatically washing vehicle 140 parked in a parking space.

### Wired Charger 8

Wired charger 8 is a charger for charging vehicle 140 parked in a parking space via a power supply cable.

### Mobile Terminal Device 130

Mobile terminal device 130 is, for example, a smart phone or a smart watch that can be carried by the user of vehicle 140.

### Vehicle 140

Vehicle 140 is a vehicle including a storage battery for traveling, such as an electric vehicle or a plug-in hybrid vehicle.

Vehicle management center 110, parking lot management center 120, mobile terminal device 130, and vehicle 140 communicate with each other through communication network NW. Communication network NW is, for example, a mobile phone network or a local line with a large number of base stations as terminals, or a satellite communication network using communication satellites.

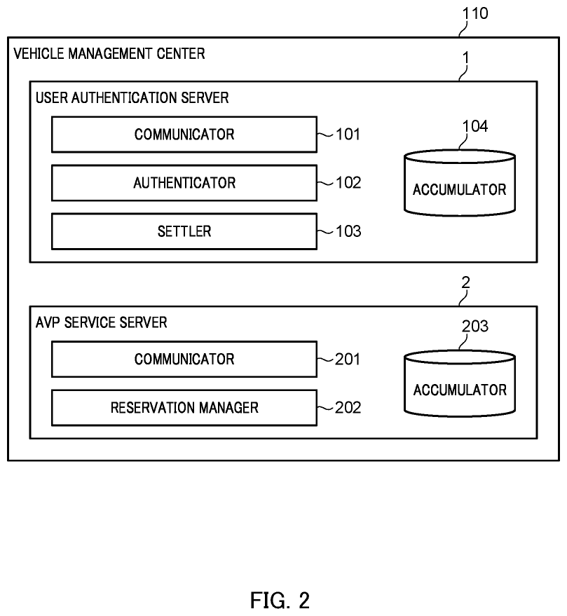

In the following, configuration examples of user authentication server 1 and AVP service server 2 will be described with reference to FIG. 2. FIG. 2 illustrates respective configuration examples of user authentication server 1 and an AVP service server 2.

### User Authentication Server 1

User authentication server 1 includes communicator 101 serving as communication means for transmitting and receiving information, authenticator 102 for authenticating a user who uses the valet parking service, settler 103, and accumulator 104.

### Authenticator 102

Authenticator 102 determines, for example, whether or not the vehicle registration number included in the vehicle information transmitted from mobile terminal device 130 matches the vehicle registration number included in the vehicle information transmitted from infrastructure camera 5.

When the vehicle registration numbers match each other, authenticator 102 transmits to control server 4 an approval notification indicating approval for use of the valet parking service.

Further, after transmitting the approval notification to control server 4, authenticator 102 introduces the correspondence information associated with the vehicle registration number into the vehicle information and transmits the information to control server 4.

The correspondence information includes information on, for example, the type of vehicle 140, the size of vehicle 140, the vehicle height of vehicle 140, the charging standard (rated power or vehicle height) of the power receiver for contactless charging mounted on the vehicle 140, and the installation position of the power receiver.

The type of vehicle 140 represents a vehicle type such as a small passenger car or a minicar. The size of vehicle 140 represents the vehicle width, overall length, and the like of vehicle 140. The vehicle height of vehicle 140 represents the minimum ground clearance.

The charging standard of a power receiver represents, for example, a charging standard such as CHAdeMO (registered trademark) or Combo (Combined Charging System). The charging standard may include information on the WPT class, information on the type of power receiving coil provided in the power receiver, information on the type of power transmitting coil provided in WPT power transmitter 6, and the like. The charging standard is not limited to the above, and may be, for example, a standard for contactless power supply to an electric vehicle (EV), such as the SAE standard.

The WPT class is a classification that defines the maximum value of power that can be input to WPT power transmitter 6, the vehicle height (classified from Z1 to Z3), the minimum required power transmission efficiency, and the like. WPT1 to WPT4 are defined in the WPT class. The maximum input power to WPT power transmitter 6 is defined as 3.7 kVA in “WPT1,” 7.7 kVA in “WPT2,” 11.1 kVA in “WPT3,” and 22 kVA in “WPT4.”

The installation position of the power receiver is, for example, in the bottom of vehicle 140 at a position near the front bumper, a position near the rear bumper, a position near the left side, a position near the right side, or a position near the center.

When the above two vehicle registration numbers match each other, authenticator 102 transfers the service information transmitted from mobile terminal device 130 to control server 4.

The service information includes information indicating the service requested by a user, such as the above-described charging service, car washing service, and refueling service. Transferring the service information to control server 4 allow for selecting a parking space that can provide these services.

The service information may include information on the target state of charge to be charged by the charging service, the scheduled parking time in the parking space, and the like. The target state of charge is a state of charge (SoC) set as a target during the charging of a storage battery for traveling mounted on vehicle 140.

### Settler 103

Settler 103 calculates the fee for using the parking space based on the information regarding the usage time of the parking lot, the time period during which the parking lot is used, and the like, and settles the usage fee.

In addition, when a service associated with the valet parking service is used, settler 103 calculates the fee for using the service and settles the usage fee.

### Accumulator 104

Accumulator 104 accumulates data related to the dates and times of payment, data related to usage fees, and the like.

### AVP Service Server 2

AVP service server 2 includes communicator 201 serving as communication means for transmitting and receiving information, reservation manager 202, and accumulator 203.

### Reservation Manager 202

Reservation manager 202 manages reservations for parking lots where the valet parking service is available.

### Accumulator 203

Accumulator 203 accumulates data related to the dates and times when the valet parking service is reserved, data related to users who used the valet parking service, and the like.

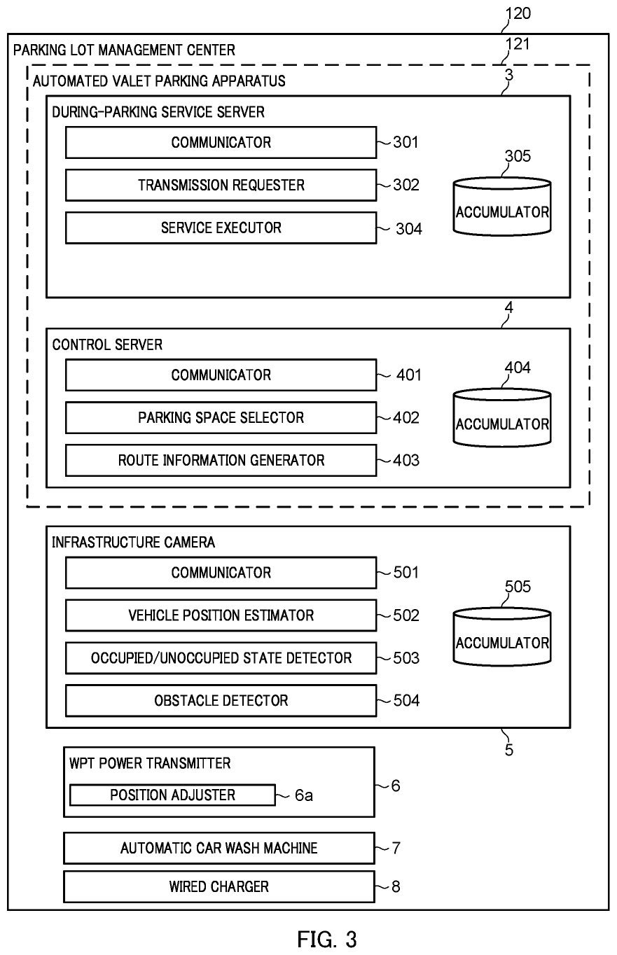

In the following, configuration examples of during-parking service server 3, control server 4, and infrastructure camera 5 will be described with reference to FIG. 3. FIG. 3 illustrates respective configuration examples of during-parking service server 3, control server 4, and infrastructure camera 5.

Automated valet parking apparatus 121 includes during-parking service server 3 and control server 4.

### During-Parking Service Server 3

During-parking service server 3 includes communicator 301 serving as communication means for transmitting and receiving information, transmission requester 302, service executor 304, and accumulator 305.

### Transmission Requester 302

Upon receiving of the transmission request signal transmitted from control server 4, transmission requester 302 transfers the transmission request signal to WPT power transmitter 6 installed in a vacant parking space. A transmission request signal is a signal requesting transmission of alignment information.

The alignment information is information indicating the installation position of WPT power transmitter 6. The alignment information is transmitted to vehicle 140, and vehicle 140 having received the alignment information starts automatic parking toward the installation position of WPT power transmitter 6 by controlling the steering amount of the steering wheel, the brake pedal, the accelerator opening, and the like.

At this time, when the installation position of the power receiver is displaced from the installation position of WPT power transmitter 6, position adjuster 6a in WPT power transmitter 6 generates positional deviation information. A method of generating positional deviation information will be described below. Position adjustment of vehicle 140 is performed based on this positional deviation information.

### Position Adjuster 6a

When vehicle 140 [symbol] uided to the front of a parking space selected by parking space selector 402 [symbol] utomatically parks in the parking space, position adjuster 6a adjusts the position of vehicle 140 in such a way that the amount of deviation of the installation position of the power receiver with respect to the installation position of WPT power transmitter 6 becomes small. The details of the configuration of parking space selector 402 will be described below.

Position adjuster 6a compares the transmitted power level transmitted from the power transmitting coil in WPT power transmitter 6 to the power receiver with the received power level received by the power receiving coil in the power receiver based on, for example, the transmitted power data transmitted from WPT power transmitter 6 and the received power data transmitted from vehicle 140 by radio communication.

Position adjuster 6a transmits a power level corresponding to the difference between the received power level and the transmitted power level as positional deviation information to vehicle 140.

The smaller the difference between the received power level and the transmitted power level, the smaller the amount of positional deviation; thus, vehicle 140 having received the positional deviation information controls the steering amount of the steering wheel, the brake pedal, the accelerator opening, and the like until the difference between the received power level and the transmitted power level becomes equal to or less than a predetermined value.

Vehicle 140 having received the positional deviation information may adjust the position of vehicle 140 in such a way that the installation position of power receiver 1 with respect to the installation position of WPT power transmitter 6 is located within a predetermined power receivable range.

### Service Executor 304

When the application for the contactless charging service has been made, service executor 304 generates an execution signal (for causing WPT power transmitter 6 to carry out contactless charging) and transmits the signal to WPT power transmitter 6 in order to carry out contactless charging for vehicle 140 having completed parking.

When the application for the automatic car wash service has been made, service executor 304 generates an execution signal (for causing automatic car wash machine 7 to carry out car washing) and transmits the signal to automatic car wash machine 7 in order to carry out car washing for vehicle 140 having completed parking into the parking space.

### Accumulator 305

Accumulator 305 accumulates data related to the dates and times when various services are executed, data related to users who used the various services, and the like.

### Control Server 4

Control server 4 includes communicator 401 serving as communication means for transmitting and receiving information, parking space selector 402, route information generator 403, and accumulator 404.

### Parking Space Selector 402

When parking space selector 402 receives an approval notification transmitted from authenticator 102 of user authentication server 1, parking space selector 402 selects a vacant parking space capable of contactless charging based on the correspondence information included in the vehicle information transmitted from authenticator 102 and the vacant parking space identification information transmitted from infrastructure camera 5.

Specifically, the correspondence information transmitted from authenticator 102 includes information relative to the charging standard of the power receiver; thus, parking space selector 402 having received the correspondence information selects a parking space, in which WPT power transmitter 6 corresponding to the charging standard of the power receiver is installed, by referring to the data recorded in accumulator 404.

In addition, parking space selector 402 detects a vacant parking space capable of contactless charging that conforms to the charging standard of the power receiver by determining whether the selected parking space is included in the vacant parking space identification information.

### Another Configuration Example 1 of Parking Space Selector 402

The correspondence information transmitted from authenticator 102 also includes information on the type of vehicle 140; thus, parking space selector 402 may be configured to determine whether or not there is a parking space available for parking in view of the type or height of vehicle 140.

### Another Configuration Example 2 of Parking Space Selector 402

The correspondence information transmitted from authenticator 102 also includes information on the size of vehicle 140; thus, parking space selector 402 may be configured to determine whether or not there is a parking space available for parking in view of the size of vehicle 140.

For example, when the vehicle width of vehicle 140 exceeds the available parking space size of a first parking space, parking space selector 402 selects a second parking space having a size that allows this vehicle 140 to be parked.

### Another Configuration Example 3 of Parking Space Selector 402

When the service information transmitted from authenticator 102 of user authentication server 1 includes information related to a service that accompanies the valet parking service, parking space selector 402 may be configured to select a parking space capable of providing the service.

### Route Information Generator 403

When route information generator 403 receives parking space position information, route information generator 403 calculates a travel route from the position of vehicle 140 (for example, where the passenger gets off at the entrance of the parking lot where the valet parking service is available) to the position of the parking space selected by parking space selector 402 based on the parking space position information.

For the calculation of a travel route, route information generator 403 may be configured to calculate the travel route from a location other than the entrance of the parking lot to the position of the parking space selected by parking space selector 402. For example, when vehicle 140 is temporarily moved to a temporary parking space near the entrance of the parking lot after the passenger gets off at the entrance of the parking lot, parking space selector 402 calculates a travel route from the temporary parking space to the position of the parking space selected by the parking space selector 402.

Route information generator 403 generates route information representing the calculated travel route and transmits the route information to vehicle 140.

Vehicle 140 having received the route information automatically travels in the parking lot and moves to the parking space selected by parking space selector 402 based on the route information. When vehicle 140 arrives in front of the parking space, vehicle 140 automatically parks in the parking space.

### Accumulator 404

Accumulator 404 accumulates information on parking spaces selected by parking space selector 402, route information generated by route information generator 403, and the like.

### Infrastructure Camera 5

Infrastructure camera 5 includes communicator 501 serving as communication means for transmitting and receiving information, vehicle position estimator 502, occupied/unoccupied state detector 503, obstacle detector 504, and accumulator 505.

### Vehicle Position Estimator 502

Vehicle position estimator 502 estimates the position of vehicle 140 in the parking lot based on image data of the inside of the parking lot captured by the imaging means. The position information indicating the estimated position of vehicle 140 is transmitted to, for example, route information generator 403 and used for calculating the travel route.

### Occupied/Unoccupied State Detector 503

Occupied/unoccupied state detector 503 determines whether or not one or more parking spaces, where WPT power transmitters 6 are installed, are in use based on the image data of the parking spaces captured by the imaging means.

When all the parking spaces are in use, occupied/unoccupied state detector 503 determines that the parking lot is full (full state), and transmits full state information indicating the full state to parking space selector 402.

When there is at least one vacant parking space, occupied/unoccupied state detector 503 determines that the parking lot is not full (in a vacant state), and transmits vacant parking space identification information indicating the position of the vacant parking space to parking space selector 402. The vacant parking space identification information is an example of occupied/unoccupied state information including vacant information of the parking space.

### Obstacle Detector 504

For example, obstacle detector 504 compares the object(s) included in a reference image recorded in accumulator 505 with the object(s) included in an image of the inside of the parking lot captured by the imaging means, thereby detecting an object that may become an obstacle to vehicle 140. The reference image is an image of a person, a vehicle, or the like that may become an obstacle to vehicle 140.

### Accumulator 505

Accumulator 505 accumulates data related to reference images. Accumulator 505 is an example of a recording apparatus for recording information that causes an operation in the one or more information processing apparatuses to be executed.

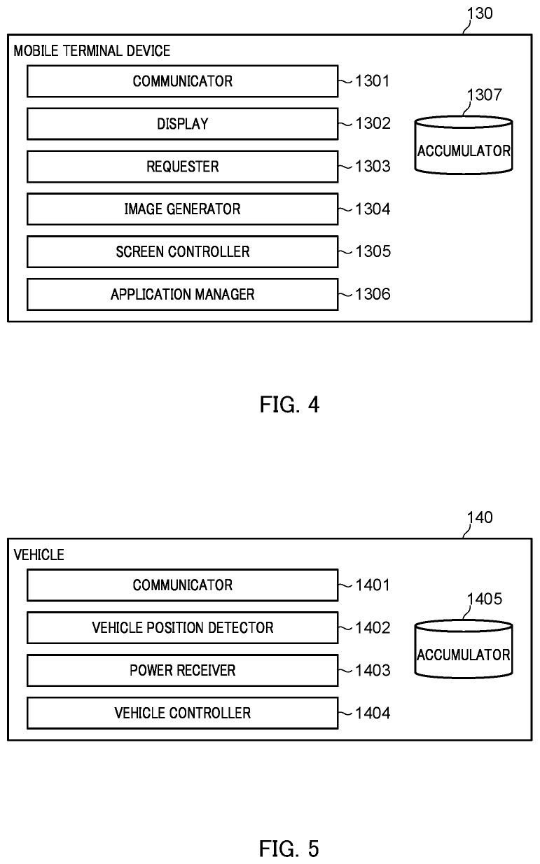

In the following, a configuration example of mobile terminal device 130 will be described with reference to FIG. 4. FIG. 4 illustrates a configuration example of mobile terminal device 130.

Mobile terminal device 130 includes communicator 1301 serving as communication means for transmitting and receiving information, display 1302 for displaying images, requester 1303, image generator 1304, screen controller 1305, application manager 1306, and accumulator 1307.

### Requester 1303

Requester 1303 requests user authentication server 1 to start authentication, and transmits a request signal to require the start of automated valet parking.

### Image Generator 1304

Image generator 1304 generates an image that is provided for an operation of mobile terminal device 130.

### Screen Controller 1305

When the application for an automated valet parking service is activated, screen controller 1305 causes display 1302 to display a reservation screen for the automated valet parking service, a reservation screen for a service(s) that accompanies the automated valet parking service, and the like.

### Application Manager 1306

Application manager 1306 manages the application of the automated valet parking service, for example, when mobile terminal device 130 is operated. Application manager 1306 causes various functions on the application screen to be executed, for example, according to the received operation.

### Accumulator 1307

Accumulator 1307 accumulates application data for the automated valet parking service.

In the following, a configuration example of vehicle 140 will be described with reference to FIG. 5. FIG. 5 illustrates a configuration example of vehicle 140.

Vehicle 140 includes communicator 1401, vehicle position detector 1402, power receiver 1403 for contactless charging, vehicle controller 1404, and accumulator 1405.

### Vehicle Position Detector 1402

Vehicle position detector 1402 receives vehicle position information (indicating the current position of vehicle 140) transmitted from a position detection apparatus (not illustrated) and detects the vehicle position.

The position detection apparatus includes, for example, an estimator using markers, a global navigation satellite system (GNSS) receiver, a gyro sensor, and a wheel speed sensor.

### Power Receiver 1403

Power receiver 1403 receives power supplied from WPT power transmitter 6 and outputs the power to the storage battery for traveling mounted on vehicle 140. Power receiver 1403 includes a power receiving coil (not illustrated) for receiving power supplied from WPT power transmitter 6 and a power conversion circuit (not illustrated).

The power receiving coil is provided at the bottom of power receiver 1403. The electric power received by the power receiving coil is converted into a DC voltage by the power conversion circuit, and then used to charge the storage battery for traveling mounted on power receiver 1403.

### Vehicle Controller 1404

When vehicle controller 1404 receives the positional deviation information transmitted from position adjuster 6a illustrated in FIG. 3, vehicle controller 1404 adjusts the position of vehicle 140 by controlling the steering amount of the steering wheel, the brake pedal, the accelerator opening, and the like in such a way that the installation position of power receiver 1 with respect to the installation position of WPT power transmitter 6 is located within a predetermined power receivable range.

### Accumulator 1405

Accumulator 1405 accumulates information on the current position of vehicle 140 and the like.

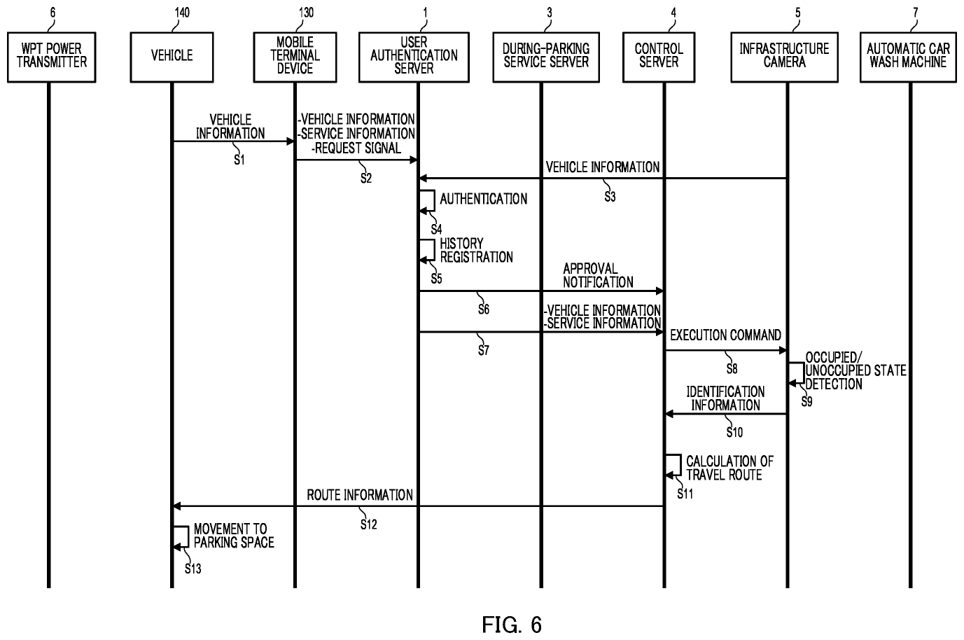

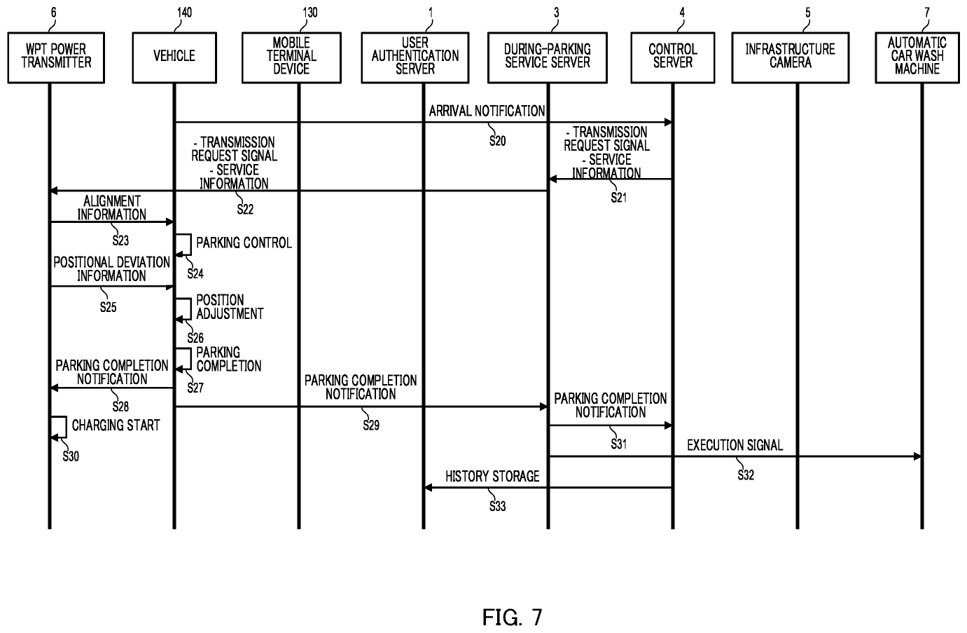

In the following, the operation of automated valet parking system 100 will be described with reference to FIGS. 6 and 7. FIGS. 6 and 7 are sequence diagrams for explaining the operation of automated valet parking system 100.

FIG. 6 illustrates processing of guiding vehicle 140, whose passenger has gotten off at the entrance of a parking lot, to the front of a vacant parking space, for example.

In step S1, vehicle information of vehicle 140 is set in mobile terminal device 130. The processing of Step S2 is then executed.

In Step S2, when vehicle 140 arrives at the parking lot, mobile terminal device 130 owned by the user of vehicle 140 transmits to user authentication server 1 the above vehicle information, service information set in advance in mobile terminal device 130, and a request signal for requesting the start of automated valet parking.

In step S3, infrastructure camera 5 transmits vehicle information to user authentication server 1. The processing of step S3 is executed in parallel with the processing of step S2.

Next, in step S4, user authentication server 1 authenticates vehicle 140. For example, when the vehicle registration number included in the vehicle information transmitted from mobile terminal device 130 matches the vehicle registration number included in the vehicle information transmitted from infrastructure camera 5, user authentication server 1 approves use of the valet parking service.

Next, in step S5, user authentication server 1 registers the approval in accumulator 104 as history information; and in step S6, authentication server 1 transmits to control server 4 an approval notification indicating approval for use of the valet parking service.

Furthermore, in step S7, user authentication server 1 transmits the vehicle information of the approved vehicle 140 and the service information transmitted from mobile terminal device 130 to control server 4.

Next, in step S8, control server 4 transmits an execution command to infrastructure camera 5 to execute occupied/unoccupied state detection.

Next, in step S9, infrastructure camera 5 having received the execution command performs occupied/unoccupied state detection. When there is at least one vacant parking space, infrastructure camera 5 transmits vacant parking space identification information indicating the position of the vacant parking space to control server 4 in step S10.

In subsequent step S11, when there is a vacant parking space capable of contactless charging, control server 4 having received the vacant parking space identification information selects the parking space and calculates the travel route of vehicle 140 to the parking space.

In step S8, infrastructure camera 5 may be configured to detect an occupied/unoccupied state in real time regardless of the execution command, and transmit the result of this occupied/unoccupied state detection to control server 4 as the vacant parking space identification information. In this case, control server 4 having received the vacant parking space identification information selects a parking space to be parked based on vehicle information, service information, and the like.

Next, in step S12, control server 4 transmits route information on the travel route to vehicle 140.

Next, in step S13, vehicle 140 having received the route information automatically travels in the parking lot and moves to the front of the parking space selected by parking space selector 402 based on the route information. Subsequently, the processing of step S20 illustrated in FIG. 7 is executed.

FIG. 7 illustrates processing of automated valet parking system 100 for parking vehicle 140 in a parking space.

In step S20, vehicle 140 having arrived in front of the parking space transmits an arrival notification signal to control server 4.

The arrival notification signal notifies that vehicle 140 traveling in the parking lot according to the route information has arrived in front of the parking space selected by control server 4.

Next, in step S21, control server 4 having received the arrival notification signal transmits a transmission request signal requesting transmission of alignment information to during-parking service server 3. In addition, control server 4 introduces information on the target state of charge, the scheduled parking time, and the like into the service information and transmits the service information to during-parking service server 3.

Next, in step S22, during-parking service server 3 transfers the received transmission request signal and service information to WPT power transmitter 6.

Next, in step S23, WPT power transmitter 6 having received the transmission request signal and the service information transmits alignment information to vehicle 140.

Next, in step S24, vehicle 140 having received the alignment information starts parking control toward the installation position of WPT power transmitter 6 by controlling the steering amount of the steering wheel, the brake pedal, the accelerator opening, and the like.

Next, in step S25, WPT power transmitter 6 compares the transmitted power level and the received power level to generate positional deviation information and transmit the positional deviation information to vehicle 140.

Next, in step S26, vehicle 140 having received the positional deviation information adjusts the position of vehicle 140 in such a way that the installation position of power receiver 1 with respect to the installation position of WPT power transmitter 6 is located within a predetermined power receivable range by controlling the steering amount of the steering wheel, the brake pedal, the accelerator opening, and the like.

Next, in step S27, when the installation position of power receiver 1 with respect to the installation position of WPT power transmitter 6 is located within a predetermined power receivable range, vehicle 140 determines that parking is completed and executes processing of step S28.

In Step S28, vehicle 140 transmits a parking completion notification indicating that parking is completed to WPT power transmitter 6. Further, in Step S29, vehicle 140 transmits the parking completion notification to during-parking service server 3.

Next, in step S30, WPT power transmitter 6 having received the parking completion notification starts contactless charging.

Next, in step S31, during-parking service server 3 having received the parking completion notification transfers the parking completion notification to control server 4.

In parallel with the processing of step S31, during-parking service server 3 generates an execution signal for causing automatic car wash machine 7 to carry out car washing, and transmits the execution signal to the automatic car wash machine 7 in step S32.

Next, in step S33, control server 4 stores the completion of parking as history information. With this, automated valet parking system 100 ends the series of processing.

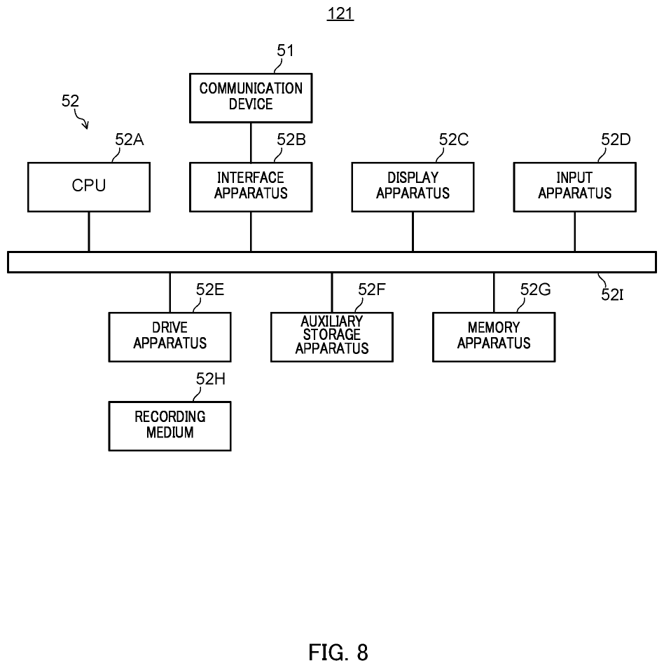

In the following, a configuration example of a hardware in automated valet parking apparatus 121 will be described with reference to FIG. 8. FIG. 8 illustrates a configuration example of a hardware in automated valet parking apparatus 121.

Automated valet parking apparatus 121 includes, as hardware 52, CPU 52A, interface apparatus 52B, display apparatus 52C, input apparatus 52D, drive apparatus 52E, auxiliary storage apparatus 52F, memory apparatus 52G, and recording medium 52H.

CPU 52A, interface apparatus 52B, display apparatus 52C, input apparatus 52D, drive apparatus 52E, auxiliary storage apparatus 52F, and memory apparatus 52G are connected via bus line 521.

Programs for implementing various functions of automated valet parking apparatus 121 is provided by, for example, recording medium 52H.

When drive apparatus 52E reads a program from recording medium 52H, the program is installed in auxiliary storage apparatus 52F.

The program may be downloaded from another computer via communication network NW illustrated in FIG. 1 and installed in auxiliary storage apparatus 52F.

Auxiliary storage apparatus 52F stores various installed programs, as well as necessary files and data.

Memory apparatus 52G reads a program from auxiliary storage apparatus 52F and stores the program, or temporarily stores data to be used by the program when there is a program activation instruction.

CPU 52A executes various programs stored in memory apparatus 52G and implements various functions related to automated valet parking apparatus 121 according to the programs.

Interface apparatus 52B is connected to communication device 51 and configured to communicate with communication device 51. Communication device 51 is a communication means connected to communication network NW illustrated in FIG. 1.

Display apparatus 52C displays a graphical user interface (GUI) according to a program that is executed by CPU 52A, for example.

Input apparatus 52D receives inputs of various operation instructions related to automated valet parking apparatus 121 from a operator, administrator, or the like of automated valet parking apparatus 121.

Parking space selector 402 may also be configured as follows.

### Another Configuration Example 4 of Parking Space Selector 402

Before charging of vehicle 140 is started, parking space selector 402 determines whether the state of charge of the storage battery for traveling mounted on vehicle 140 would reach a target state of charge of the storage battery for traveling by the time vehicle 140 exits the parking space, based on state of charge setting information that sets the target state of charge. When it is determined that the state of charge would not reach the target state of charge, parking space selector 402 selects a parking space where wired charger 8 is installed in place of a parking space where WPT power transmitter 6 is installed.

Such a configuration allows charging of the storage battery for traveling to near full charge in a short period of time; therefore, the traveling distance of vehicle 140 after exiting the parking space can be extended.

### Another Configuration Example 5 of Parking Space Selector 402

When parking space selector 402 receives information indicating that charging by wired charger 8 is not desired, parking space selector 402 selects a parking space where WPT power transmitter 6 is installed. Alternatively, when parking space selector 402 receives information indicating that charging by wired charger 8 is desired, parking space selector 402 selects a parking space where wired charger 8 is installed.

Such a configuration allows a user of vehicle 140 to select a charging method that meets the needs of the user, thereby increasing the use of the parking lot and possibly increasing the repeat rate of a department store, a hotel, or the like attached to the parking lot.

As described above, automated valet parking apparatus 121 according to one embodiment of the present disclosure enables the following configuration. After vehicle 140 automatically travels to a parking space in a parking lot that supports automated valet parking, the position of vehicle 140 can be automatically adjusted in such a way that the amount of deviation of the installation position of the power receiver of vehicle 140 with respect to the installation position of WPT power transmitter 6 in the parking space becomes small.

With this configuration, without installing a mechanism for adjusting the position of WPT power transmitter 6 in a parking space for example, inexpensive equipment can be used to adjust the installation position of the power receiver to match the installation position of WPT power transmitter 6, regardless of, for example, the type of vehicle 140, the size of vehicle 140, and the installation position of the power receiver.

Therefore, it is possible to provide an automated valet parking while limiting an increase in costs for constructing a parking lot capable of automated valet parking.

In addition, there is no need to install a mechanism for adjusting the position of WPT power transmitter 6 in a parking space, an automated valet parking service can be started earlier, thereby increasing the profits of a related organization such as a management company that manages the operation of the parking lot.

The installation of WPT power transmitter 6 enables unmanned implementation of both of the valet parking service and the charging service. Therefore, in addition to significantly reducing labor costs for parking lot management, it is also possible to provide these services on a 24-hour basis.

For users who use the automated valet parking service, there is no need to move vehicle 140 to the parking space after arriving at the parking lot. These users can increase the time to experience activities at the target facility such as a department store or a hotel attached to the parking lot.

Automated valet parking system 100 according to one embodiment of the present disclosure may also be configured as follows.

### Another Configuration Example

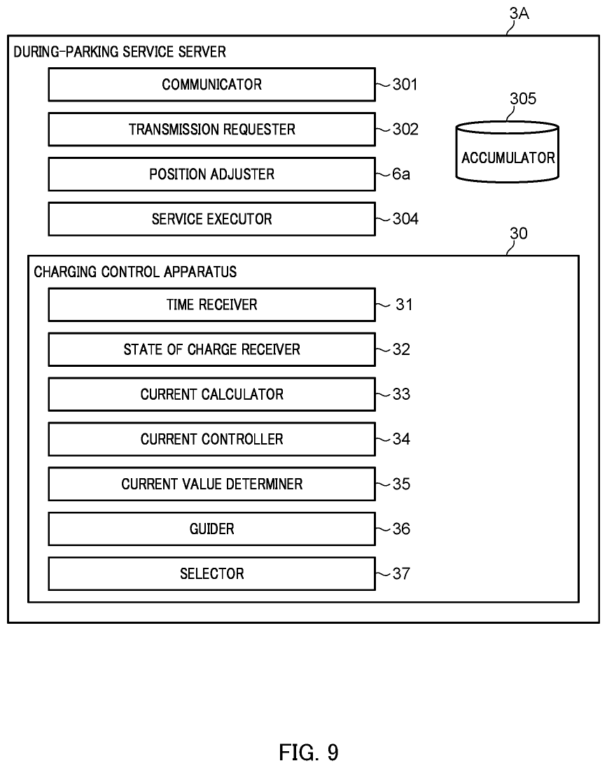

FIG. 9 illustrates a configuration example of during-parking service server 3A. During-parking service server 3A further includes charging control apparatus 30 in addition to communicator 301, transmission requester 302, position adjuster 6a, service executor 304, and accumulator 305, which are described above.

### Charging Control Apparatus 30

Charging control apparatus 30 includes time receiver 31, state of charge receiver 32, current calculator 33, current controller 34, current value determiner 35, guider 36, and selector 37.

### Time Receiver 31

Time receiver 31 receives a scheduled parking time. The scheduled parking time is defined as a time period from the scheduled entry time to the scheduled exit time in the case of vehicle 140 entering a parking space where a power transmitter corresponding to the power receiver of vehicle 140 is installed. The scheduled parking time is set, for example, by operating an application installed in mobile terminal device 130 owned by the user of vehicle 140.

The power receiver is, for example, a power receiver for contactless charging of a wireless charging system or a power receiver of a wired charging system. The power transmitter is a power transmitter of a wireless charging system or a power transmitter of a wired charging system. The parking space is, for example, a parking space where WPT power transmitter 6 is installed, or a parking space where wired charger 8 is installed.

Upon receiving service information transmitted from mobile terminal device 130 illustrated in FIG. 6 for example, time receiver 31 receives the scheduled parking time (in the parking space) included in the service information.

Alternatively, the scheduled parking time may be set by, for example, operating an in-vehicle device such as a center display of vehicle 140 instead of setting by operating mobile terminal device 130. In this case, time receiver 31 receives the scheduled parking time by reading the information on the scheduled parking time set in vehicle 140.

### State of Charge Receiver 32

State of charge receiver (namely, a unit that receives a state of charge) 32 receives a target state of charge included in the service information transmitted from mobile terminal device 130, for example.

Alternatively, the target state of charge may be set by, for example, operating an in-vehicle device such as a center display of vehicle 140 instead of setting by operating mobile terminal device 130. In this case, time receiver 31 receives the target state of charge by reading the information on the target state of charge set in vehicle 140.

### Current Calculator 33

Current calculator 33 calculates a current value that allows the state of charge of the storage battery for traveling to reach the target state of charge received by state of charge receiver 32 when the scheduled parking time received by time receiver 31 has passed.

The time “when the scheduled parking time has passed” may include, for example, an allowable range centered on the scheduled exit time, including a predetermined time before that time, a predetermined time after that time, or a predetermined time before and after that time. The predetermined time is, for example, several tens of seconds or several minutes.

For example, when the scheduled exit time is “15:10,” current calculator 33 calculates a current value that allows the state of charge of the storage battery for traveling to reach the target state of charge received by state of charge receiver 32 by the time between “15:00,” which is before the scheduled exit time, and “15:10,” which is the scheduled exit time.

For example, the state of charge of the storage battery for traveling may be included in the vehicle information transmitted from vehicle 140 to during-parking service server 3A by wireless communication, may be included in the vehicle information transmitted from vehicle 140 to mobile terminal device 130, or may be obtained by communication between the WPT power transmitter and receiver and transmitted from WPT power transmitter 6 to during-parking service server 3A.

### Current Controller 34

Current controller 34 charges a storage battery for traveling with the current value calculated by current calculator 33. In addition, when the state of charge of the storage battery for traveling reaches the target state of charge of the storage battery for traveling, current controller 34 reduces the current value.

For example, when charging vehicle 140 (parked in a parking space) with a power transmitter of a wireless charging system (WPT power transmitter 6) is started, current controller 34 generates a current command value for outputting a current corresponding to the current value calculated by current calculator 33 during the time period from when the charging is started to when the scheduled parking time has passed. Current controller 34 introduces the current command value into the service information illustrated in FIG. 7 and transmits the service information to WPT power transmitter 6.

WPT power transmitter 6 having received the current command value outputs a current of a predetermined value based on the current command value, during the time period from when charging is started to when the scheduled parking time has passed.

At the time when the scheduled parking time has passed, current controller 34 stops transmission of the current command value in order to end the charging of the storage battery for traveling.

### Another Configuration Example 1 of Current Controller 34

Instead of stopping the transmission of the current command value, current controller 34 may generate and transmit a current command value for continuously outputting a weak current. This configuration allows for compensation for a decrease in the power stored in the storage battery for traveling caused by natural discharge.

### Another Configuration Example 2 of Current Controller 34

Current controller 34 may be configured to reduce the current value after the temperature of the storage battery for traveling reaches a predetermined value to lower than the current value before the temperature of the storage battery for traveling reaches the predetermined value.

For example, current controller 34 receives temperature information transmitted from a temperature sensor measuring the temperature of the storage battery for traveling and compare a predetermined value (predetermined temperature setting value) set in advance in current controller 34 with the temperature measured by the temperature sensor.

When the measured temperature is less than the predetermined value as a result of the comparison, current controller 34 generates a current command value for outputting a current corresponding to the current value calculated by current calculator 33 and transmits the current command value to the power receiver.

When the measured temperature rises and exceeds the predetermined value, current controller 34 generates a current command value for outputting a current lower than the current corresponding to the current value calculated by current calculator 33 and transmits the current command value to the power receiver, in order to prevent the progress of deterioration of the storage battery for traveling.

The current lower than the current corresponding to the current value calculated by current calculator 33 may be any current that can prevent an increase in the temperature of the storage battery for traveling, and is, for example, a current that decreases stepwise or continuously after the temperature of the storage battery for traveling exceeds a predetermined value.

### Current Value Determiner 35

Current value determiner 35 determines whether or not the current value during charging of the storage battery for traveling is less than the current value calculated by current calculator 33, and transmits information indicating the determination result to guider 36.

For example, when charging is performed by using a power transmitter of a wireless charging system, such as WPT power transmitter 6, the current value during the charging tends to be lower than when using a power transmitter of a wired system. Therefore, when a power transmitter of a wireless charging system is used, the current value during charging of a storage battery for traveling may be determined as less than the current value calculated by current calculator 33.

### Guider 36

When the current value during charging of a storage battery for traveling is determined as less than the current value calculated by current calculator 33 based on the information indicating the determination result transmitted from current value determiner 35, guider 36 generates a guidance command for guiding vehicle 140 to a parking space where a wired power transmitter is installed. Alternatively, in place of a wired power transmitter, guider 36 generates a guidance command for guiding vehicle 140 to a parking space where a charger having higher transmission power than a transmitter for contactless charging (whose current value during charging of the storage battery for traveling is determined as less than the current value calculated by current calculator 33) among transmitters for contactless charging. The generated guidance command is transmitted to vehicle 140.

Vehicle 140 having received the guidance command is moved by automatic driving to a parking space where, for example, a wired power transmitter or a charger with high transmission power is installed.

When vehicle 140 having received the guidance command uses an automated valet parking service, for example, vehicle 140 causes the application of mobile terminal device 130 to display a text message showing that the vehicle is to move to another parking space. Alternatively, vehicle 140 having received the guidance command may display a text message showing that the vehicle is to move to another parking space on a screen such as a center display provided in vehicle 140, or vehicle 140 may replay voice guidance announcing that the vehicle is to move to another parking space from a speaker within vehicle 140.

Accordingly, the driver of vehicle 140 can select whether or not to move vehicle 140 to another parking space or continue charging without moving vehicle 140 after checking the charging state.

### Selector 37

Selector 37 selects either a first charging mode in which the storage battery for traveling is charged with a first current value calculated by current calculator 33 or a second charging mode in which the storage battery for traveling is charged with a second current value higher than the first current value.

For example, a user of vehicle 140 who places importance on preventing the progress of deterioration of the storage battery for traveling selects the first charging mode on the screen of an application installed in mobile terminal device 130 owned by the user.

On the other hand, a user who places importance on rapidly charging the storage battery for traveling to near full charge in a short period of time selects the second charging mode on the screen of the application.

Information indicating the first charging mode or information indicating the second charging mode is included in the above-described service information and transmitted to charging control apparatus 30.

Upon receiving the information indicating the first charging mode, current controller 34 of charging control apparatus 30 generates a current command value for outputting the first current value calculated by current calculator 33, and transmits the current command value to the power transmitter. As a result, the storage battery for traveling can be charged with the first current value. The power transmitter may be either a power transmitter of a wireless charging system or a power transmitter of a wired charging system.

Upon receiving the information indicating the second charging mode, current controller 34 of charging control apparatus 30 generates a current command value for outputting a second current value higher than the first current value, and transmits the current command value to the power transmitter. As a result, the storage battery for traveling can be charged with the second current value. The power transmitter may be either a power transmitter of a wireless charging system or a power transmitter of a wired charging system.

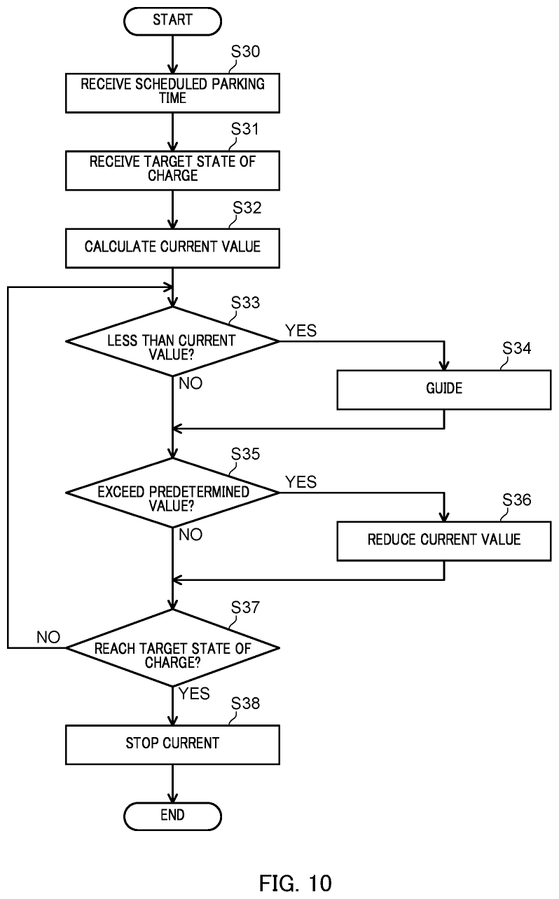

In the following, the operation of charging control apparatus 30 will be described with reference to FIGS. 10 to 12.

FIG. 10 is a flow chart for explaining the operation of charging control apparatus 30. In Step S30, time receiver 31 receives a scheduled parking time.

Next, in step S31, state of charge receiver 32 receives a target state of charge of a storage battery for traveling mounted on vehicle 140.

Next, in step S32, current calculator 33 calculates a current value that allows the state of charge of the storage battery for traveling to reach the target state of charge when the scheduled parking time has passed.

Next, in step S33, current value determiner 35 determines whether or not the charging current value during charging of the storage battery for traveling is less than the current value calculated by current calculator 33.

When the charging current value is less than the current value calculated by current calculator 33 (step S33, YES), the processing of step S34 is executed.

In Step S34, guider 36 identifies another parking space where a power transmitter capable of outputting a charging current value equal to or greater than the current value calculated by current calculator 33 is installed by, for example, referring to the data recorded in accumulator 305 provided in during-parking service server 3A.

Guider 36 generates a guidance command for guiding vehicle 140 to the other identified parking space. After Step S34, the processing of Step S35 is executed. The processing of step S35 will be described below.

Returning to step S33, when the charging current value exceeds the current value calculated by current calculator 33 (step S33, NO), the processing of step S35 is executed.

In step S35, current calculator 33 determines whether or not the temperature of the storage battery for traveling has exceeded a predetermined value.

When the temperature of the storage battery for traveling exceeds the predetermined value (step S35, YES), the processing of step S36 is executed.

In Step S36, current controller 34 reduces the current value after the temperature of the storage battery for traveling exceeds the predetermined value to lower than the current value before the temperature of the storage battery for traveling exceeds the predetermined value. After Step S36, the processing of Step S37 is executed. The processing of step S37 will be described below.

Returning to step S35, when the temperature of the storage battery for traveling does not exceed the predetermined value (step S35, NO), the processing of step S37 is executed.

In Step S37, current controller 34 determines whether or not the state of charge of the storage battery for traveling has reached the target state of charge of the storage battery for traveling.

When the state of charge has not reached the target state of charge (step S37, NO), the processing after step S33 is repeated.

When the state of charge reaches the target state of charge (step S37, YES), the processing of step S38 is executed.

In Step S38, current controller 34 ends the charging of the storage battery for traveling by stopping the current or reducing the value of the current. The series of processing are thus ended. As a result, when the driver returns to the vehicle, the vehicle can exit the parking space with the state of charge having reached the target state of charge.

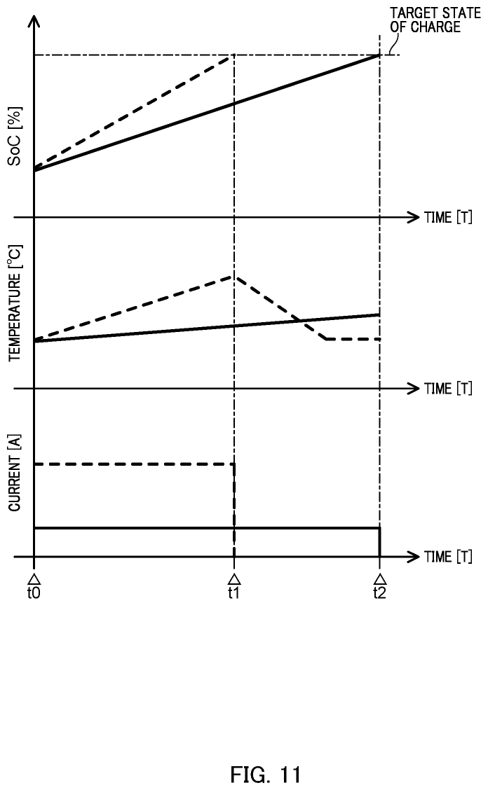

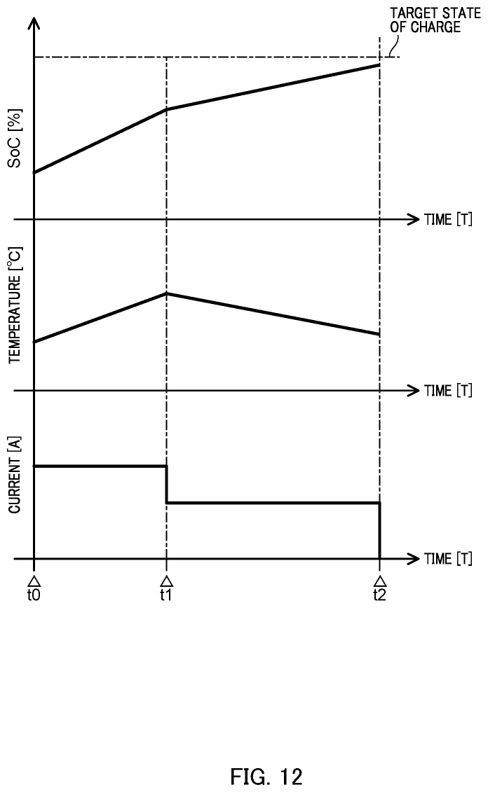

FIGS. 11 and 12 each illustrate changes in current, temperature, and the like during charging. The abscissa in each of FIGS. 11 and 12 represents time. Each of the dashed lines extending vertically in FIGS. 11 and 12 is a line for clarifying the relationship between data at the same time.

FIGS. 11 and 12 each illustrate, from top to bottom, the SoC, the temperature of a storage battery for traveling, and the charging current of the storage battery for traveling. Hereinafter, the charging current may be simply referred to as “current.”

The solid lines in FIGS. 11 and 12 represent the SoC, the temperature, and the charging current when the storage battery for traveling is charged with the current that allows the state of charge of the storage battery for traveling to reach the target state of charge. This charging current is a current for charging with a low current value based on the scheduled parking time and the target state of charge.

The dashed lines in FIG. 11 represent the SoC, the temperature, and the charging current when the storage battery for traveling is charged with the current that allows the state of charge of the storage battery for traveling to reach the target state of charge at time t1, which is a certain time before time t2. This charging current is a current for charging with a high current value near the rating. Time t0 is the time when charging of the storage battery for traveling is started.

### Example of Current Control in FIG. 11

In FIG. 11, when charging is performed with the current indicated by the dashed line, the state of charge of the storage battery for traveling reaches the target state of charge at time t1, which is a certain time before time t2 (i.e., scheduled parking time). There is thus a risk that the temperature of the storage battery for traveling would rise sharply, and the deterioration of the storage battery for traveling may progress.

On the other hand, when charging is performed with the current indicated by the solid line, the state of charge of the storage battery for traveling reaches the target state of charge at time t2 (which is when the scheduled parking time has passed); thus the progress of deterioration of the storage battery for traveling can be prevented.

In addition, the state of charge of the storage battery for traveling would reach the target state of charge at time t2; thus, the charging amount set by the user of vehicle 140 can be achieved at the time of vehicle 140 exiting the parking space.

In addition, the current value can be reduced by charging the storage battery for traveling in such a way that its state of charge reaches the target state of charge at time t2. The temperature rise of parts such as capacitors and switch elements that constitute the power transmitter, the power receiver, and the like thus can be prevented. Therefore, the life of these parts can be greatly extended.

In addition, when the current is controlled as illustrated in FIG. 11, the value of the current can be lowered. Therefore, surplus power can be used to charge vehicles 140 that are being charged in other parking spaces while preventing an increase in peak power in the entire parking lot.

By preventing the increase in peak power in the entire parking lot, the management of the power supply for power receiving and distributing equipment installed in the parking lot becomes easier. Therefore, it becomes possible to provide charging services to a larger number of vehicles 140 without reinforcing the power receiving and distributing equipment.

### Example of Current Control in FIG. 12

As illustrated in FIG. 12, an increase in the temperature of the storage battery for traveling can be prevented by reducing the current value when the temperature of the storage battery for traveling reaches a predetermined value.

For example, from time t0 to time t1 (at which the temperature of the storage battery for traveling reaches a predetermined value), the current value is set to a high value, thereby bringing the state of charge of the storage battery for traveling close to the target state of charge in a short period of time.

Then, the current value is set to a low value after the temperature of the storage battery for traveling reaches a predetermined value at time t1. As a result, the state of charge of the storage battery for traveling can be increased up to the target state of charge while the temperature rise of the storage battery for traveling is prevented.

Controlling the current in this manner also allows the state of charge of the storage battery for traveling to reach the target state of charge at time t2; thus, the charging amount set by the user of vehicle 140 can be achieved by the time of vehicle 140 exiting the parking space.

In addition, when the current is controlled as illustrated in FIG. 12, for example, even when vehicle 140 exits the parking space before the scheduled parking time passes, the traveling distance of the vehicle 140 can be extended because the state of charge of the storage battery for traveling is already high.

When the current is controlled as illustrated in FIG. 12, the current value decreases after time t1. Therefore, surplus power can be used to charge vehicles 140 that are being charged in other parking spaces while preventing an increase in peak power in the entire parking lot as illustrated in FIGS. 11 and 12.

When the current is controlled as illustrated in FIG. 12, it is possible to level peak power by, for example, increasing the current value for rapid charging during a time period when the number of vehicles 140 being charged is small, and reducing the current value during a time period when the number of vehicles 140 being charged is large. Therefore, it is possible to provide an automated valet parking while limiting an increase in costs for constructing a parking lot capable of automated valet parking.

Charging control apparatus 30 according to one embodiment of the present disclosure can be applied not only to parking lots that support automated valet parking, but also to parking lots in which vehicles 140 are driven by manual operation, self-driving parking lots placed in commercial facilities, and the like.

When charging control apparatus 30 according to one embodiment of the present disclosure is applied to a parking lot that supports automated valet parking, parking lot management center 120 managing the parking lot can manage the scheduled parking times for one or more vehicles 140 that use the automated valet parking service at the time the automated valet parking service reservation is made. Therefore, for example, for users who desire the above charging control, it becomes possible to provide various services such as discounts on automated valet parking fees or on usage fees at department stores attached to the parking lots.

The present embodiment describes an example in which charging control apparatus 30 is provided in during-parking service server 3A; however, charging control apparatus 30 may be installed, for example, in control server 4, user authentication server 1, AVP service server 2, and the like illustrated in FIG. 1.

User authentication server 1, AVP service server 2, during-parking service server 3, control server 4, and the like are examples of information processing apparatuses according to one embodiment of the present disclosure. The information processing apparatus includes at least one of these servers.

### Charging Service Providing Method

The charging control system according to the present embodiment may be configured to implement the charging service providing method described below.

The charging control system receives the following from a information terminal: information indicating the scheduled parking time of a vehicle in a parking space where a power transmitter corresponding to the power receiver mounted on the vehicle is installed; and information indicating the target state of charge of the storage battery for traveling mounted on the vehicle. The information terminal is, for example, mobile terminal device 130 described above.

When it is possible to control the charging current of the storage battery for traveling in such a way that the state of charge of the storage battery reaches the target state of charge when the scheduled parking time has passed, the charging control system transmits notification information notifying that parking in the parking space has been received to the information terminal and performs the control of the charging current.

When it is not possible to control the charging current of the storage battery for traveling in such a way that the state of charge of the storage battery reaches the target state of charge when the scheduled parking time has passed, the charging control system transmits notification information to the information terminal to notify that the state of charge would not reach the target state of charge.

### Method for Presenting Information on Information Terminal

The charging control system according to the present embodiment may be configured to implement the below-described method for presenting information on an information terminal as follows. The information terminal is, for example, mobile terminal device 130 described above. The information terminal receives, for example, a user's operation input to the touch panel display of the information terminal, or receives a user's voice input to the microphone of the information terminal.

The information terminal transmits the following to the charging control system: information indicating the scheduled parking time of a vehicle in a parking space where a power transmitter corresponding to the power receiver mounted on the vehicle is installed; and information indicating the target state of charge of the storage battery for traveling mounted on the vehicle.

The information terminal outputs a notification indicating that parking in the parking space has been received when charging the storage battery for traveling up to the target state of charge is possible by the following: performing control of the charging current of the storage battery for traveling in such a way that the state of charge of the storage battery for traveling reaches the target state of charge when the scheduled parking time has passed. The notification is, for example, displayed as a text message or the like on the display of the information terminal, or replayed as voice guidance or the like from the speaker of the information terminal.

When it is not possible to control the charging current of the storage battery for traveling in such a way that the state of charge of the storage battery reaches the target state of charge when the scheduled parking time has passed, the information terminal outputs a notification indicating that the state of charge would not reach the target state of charge. The notification is, for example, displayed as a text message or the like on the display of the information terminal, or replayed as voice guidance or the like from the speaker of the information terminal.

It should be understood that the following aspects also belong to the technical scope of the present disclosure.
(1) A charging control apparatus according to one embodiment of the present disclosure includes: a time receiver that receives information indicating a scheduled parking time of a vehicle in a parking space where a power transmitter corresponding to a power receiver mounted on the vehicle is installed; a state of charge receiver that receives information indicating a target state of charge of a storage battery for traveling mounted on the vehicle; and a current controller that controls a charging current of the storage battery for traveling in such a way that a state of charge of the storage battery for traveling reaches the target state of charge when the scheduled parking time has passed.
(2) The power transmitter is a power transmitter for contactless charging.
(3) The charging control apparatus according to one embodiment of the present disclosure further includes: a current calculator that calculates a current value of the storage battery for traveling in such a way that the state of charge of the storage battery for traveling reaches the target state of charge when the scheduled parking time has passed; a current value determiner that determines whether or not a charging current value to the storage battery for traveling received by the power receiver corresponding to the power transmitter for contactless charging is less than the current value calculated by the current calculator; and a guider that gives an instruction to guide the vehicle to a parking space where a wired power transmitter or a charger is installed when the charging current value is less than the current value, wherein the charger is among a plurality of the transmitters for contactless charging and has higher transmission power than a transmitter for contactless charging whose charging current value is determined as less than the current value.
(4) The charging control apparatus according to one embodiment of the present disclosure further includes: a current calculator that calculates a current value of the storage battery for traveling in such a way that the state of charge of the storage battery for traveling reaches the target state of charge when the scheduled parking time has passed; and a selector that selects either a first charging mode in which the storage battery for traveling is charged with a first current value calculated by the current calculator or a second charging mode in which the storage battery for traveling is charged with a second current value higher than the first current value, wherein the current controller charges the storage battery for traveling with the first current value when the first charging mode is selected, and charges the storage battery for traveling with the second current value when the second charging mode is selected.
(5) When the parking space is a parking space supporting automated valet parking, the time receiver receives information indicating the scheduled parking time of the vehicle in the parking space supporting the automated valet parking.
(6) The current controller reduces the current value after a temperature of the storage battery for traveling reaches a predetermined value to lower than the current value before the temperature of the storage battery for traveling reaches the predetermined value.
(7) The current controller continuously outputs a current that compensates for a decrease in power stored in the storage battery for traveling caused by natural discharge after the scheduled parking time has passed.
(8) The target state of charge is set by an operation of a user.
(9) A charging control system according to one embodiment of the present disclosure includes: the above-described charging control apparatus and the power transmitter.
(10) A charging service providing method according to one embodiment of the present disclosure includes: receiving, from an information terminal, information indicating a scheduled parking time of a vehicle in a parking space where a power transmitter corresponding to a power receiver mounted on the vehicle is installed and information indicating a target state of charge of a storage battery for traveling mounted on the vehicle; when it is possible to control a charging current of the storage battery for traveling in such a way that a state of charge of the storage battery for traveling reaches the target state of charge when the scheduled parking time has passed, transmitting notification information notifying that parking in the parking space has been received to the information terminal and performing control of the charging current; and when it is not possible to control the charging current of the storage battery for traveling in such a way that the state of charge reaches the target state of charge when the scheduled parking time has passed, transmitting notification information notifying that the state of charge does not reach the target state of charge to the information terminal.
(11) An information presenting method according to one embodiment of the present disclosure is a method for presenting information on an information terminal and includes: transmitting information indicating a scheduled parking time of a vehicle in a parking space where a power transmitter corresponding to a power receiver mounted on the vehicle is installed and information indicating a target state of charge of a storage battery for traveling mounted on the vehicle; and when charging the storage battery for traveling up to the target state of charge is possible by performing control of a charging current of the storage battery for traveling in such a way that a state of charge of the storage battery for traveling reaches the target state of charge when the scheduled parking time has passed, outputting a notification indicating that parking in the parking space has been received.
(12) The information presenting method according to one embodiment of the present disclosure further includes: when it is not possible to control the charging current of the storage battery for traveling in such a way that the state of charge reaches the target state of charge when the scheduled parking time has passed, outputting a notification indicating that the state of charge does not reach the target state of charge.

Various embodiments have been described above with reference to the drawings, but it goes without saying that the present disclosure is not limited to such examples. It is obvious that a person skilled in the art can conceive various alteration examples and correction examples within the scope described in the present disclosure. It is naturally understood that these alteration examples and correction examples also belong to the technical scope of the present disclosure. Further, various components in the above-described embodiment may be arbitrarily combined without departing from the spirit of the disclosure.

Specific examples of the present disclosure have been described in detail above, but these specific examples are mere examples and do not limit the scope of the claims. The technology described in the scope of the claims may include various variations and changes made to the specific examples exemplified in the present disclosure.

This application is entitled to and claims the benefit of Japanese Patent Application No. 2021-047427 filed on Mar. 22, 2021, the disclosure of which including the specification, drawings and abstract is incorporated herein by reference in its entirety.

### INDUSTRIAL APPLICABILITY

An embodiment of the present disclosure is suitable for a charging control apparatus, charging control system, a charging service providing method, and an information presenting method.

1. A charging control apparatus comprising:
a time receiver that receives information indicating a scheduled parking time of a vehicle in a parking space where a power transmitter corresponding to a power receiver mounted on the vehicle is installed;
a state of charge receiver that receives information indicating a target state of charge of a storage battery for traveling mounted on the vehicle; and
a current controller that controls a charging current of the storage battery for traveling in such a way that a state of charge of the storage battery for traveling reaches the target state of charge when the scheduled parking time has passed.

2. The charging control apparatus according to claim 1, wherein the power transmitter is a power transmitter for contactless charging.

3. The charging control apparatus according to claim 2, further comprising:
a current calculator that calculates a current value of the storage battery for traveling in such a way that the state of charge of the storage battery for traveling reaches the target state of charge when the scheduled parking time has passed;
a current value determiner that determines whether or not a charging current value to the storage battery for traveling received by the power receiver corresponding to the power transmitter for contactless charging is less than the current value calculated by the current calculator; and
a guider that gives an instruction to guide the vehicle to a parking space where a wired power transmitter or a charger is installed when the charging current value is less than the current value, wherein the charger is among a plurality of the transmitters for contactless charging and has higher transmission power than a transmitter for contactless charging whose charging current value is determined as less than the current value.

4. The charging control apparatus according to claim 1, further comprising:
a current calculator that calculates a current value of the storage battery for traveling in such a way that the state of charge of the storage battery for traveling reaches the target state of charge when the scheduled parking time has passed;
a selector that selects either a first charging mode in which the storage battery for traveling is charged with a first current value calculated by the current calculator or a second charging mode in which the storage battery for traveling is charged with a second current value higher than the first current value,
wherein
the current controller charges the storage battery for traveling with the first current value when the first charging mode is selected, and charges the storage battery for traveling with the second current value when the second charging mode is selected.

5. The charging control apparatus according to claim 1, wherein when the parking space is a parking space supporting automated valet parking, the time receiver receives information indicating the scheduled parking time of the vehicle in the parking space supporting the automated valet parking.

6. The charging control apparatus according to claim 1, wherein the current controller reduces a current value after a temperature of the storage battery for traveling reaches a predetermined value to lower than the current value before the temperature of the storage battery for traveling reaches the predetermined value.

7. The charging control apparatus according to claim 1, wherein after the scheduled parking time has passed, the current controller continuously outputs a current that compensates for a decrease in power stored in the storage battery for traveling caused by natural discharge.

8. The charging control apparatus according to claim 1, wherein the target state of charge is set by an operation of a user.

9. A charging control system comprising: the charging control apparatus according to claim 1 and the power transmitter.

10. A charging service providing method, comprising:
receiving, from an information terminal, information indicating a scheduled parking time of a vehicle in a parking space where a power transmitter corresponding to a power receiver mounted on the vehicle is installed and information indicating a target state of charge of a storage battery for traveling mounted on the vehicle;
when it is possible to control a charging current of the storage battery for traveling in such a way that a state of charge of the storage battery for traveling reaches the target state of charge when the scheduled parking time has passed, transmitting notification information notifying that parking in the parking space has been received to the information terminal and performing control of the charging current; and
when it is not possible to control the charging current of the storage battery for traveling in such a way that the state of charge reaches the target state of charge when the scheduled parking time has passed, transmitting notification information notifying that the state of charge does not reach the target state of charge to the information terminal.

11. A method for presenting information on an information terminal, the method comprising:
transmitting information indicating a scheduled parking time of a vehicle in a parking space where a power transmitter corresponding to a power receiver mounted on the vehicle is installed and information indicating a target state of charge of a storage battery for traveling mounted on the vehicle; and
when charging the storage battery for traveling up to the target state of charge is possible by performing control of a charging current of the storage battery for traveling in such a way that a state of charge of the storage battery for traveling reaches the target state of charge when the scheduled parking time has passed, outputting a notification indicating that parking in the parking space has been received.

12. The method according to claim 11, further comprising: when it is not possible to control the charging current of the storage battery for traveling in such a way that the state of charge reaches the target state of charge when the scheduled parking time has passed, outputting a notification indicating that the state of charge does not reach the target state of charge.
